(19) United States
(12) Patent Application Publication
(10) Pub. No.: US 2005/0048922 A1
(43) Pub. Date: Mar. 3, 2005

(54) Reverse link combination device and method in a mobile communication system supporting a softer handoff

(76) Inventors: Hee-Kwang Lee, Suwon-si (KR); Young-Ky Kim, Seoul (KR); Jae-Ho Jeon, Seongnam-si (KR); Ha-Young Yang, Yongin-si (KR); Chang-Soo Park, Yongin-si (KR); Jae-Ho Lee, Seoul (KR); Byung-Chan Ahn, Seongnam-si (KR); Myung-Kwang Byun, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/927,058

(22) Filed: Aug. 27, 2004

(30) Foreign Application Priority Data
Aug. 30, 2003 (KR) 2003-60629

(51) Int. Cl. H04Q 7/20

(52) U.S. Cl. 455/65; 455/63.1

(57) ABSTRACT

Disclosed is a base station device and method for supporting communication service for a mobile station which is located in a cell divided into a plurality of sectors. The device and method comprise a receiver for receiving a signal, which is transmitted from the mobile station, through multiple paths via the plurality of sectors, and demodulating and outputting the received signal; and a combiner for combining and outputting signals output from the receiver.

### PRIORITY

This application claims the benefit under 35 U.S.C. 119(a) of an application entitled “Reverse link combination device and method in mobile communication system supporting softer handoff” filed in the Korean Intellectual Office on Aug. 30, 2003 and assigned Serial No. 2003-60629, the entire contents of which are incorporated herein by reference.

### BACKGROUND OF THE INVENTION

1. Field of the Invention

The present invention relates to a code division multiple access (hereinafter, simply referred to as ‘CDMA’) mobile communication system and a method thereof. More particularly, the present invention relates to a reverse link received signals combination device and a method thereof in a base station which supports a cell divided into multiple sectors.

2. Description of the Related Art

A CDMA-mode communication system includes a plurality of base stations for providing service to mobile stations located in a predetermined region and a base station controller, and also includes a base station management system, a switching center system, and a location registration system to manage a plurality of base station controllers. A region to which each of the base stations provides service is called a “cell”, and one cell is generally divided into three sectors. A mobile station located in the cell establishes a traffic channel and so forth between the mobile station and a base station providing service to the relevant cell, and performs communication of voice information and data through the established traffic channel.

The above-mentioned CDMA mobile communication system provides a handoff function, which is a process required when a mobile station moves from the coverage area of one base station into the coverage area of another base station, or when a mobile station moves from a region of an antenna to a different region of a base station, that is, when a mobile station changes from one traffic channel to a new traffic channel.

During the handoff process, it is very important not to deteriorate the communication quality by integrating signals and voice information transmitted from multiple base stations. Various handoff schemes are provided In a CDMA system so as to maintain the continuity of a call. Handoffs may show a difference according to the scheme and processed contents of each, from the viewpoint of maintaining the continuity of a call, load on the system, and so on.

The various handoff schemes include a soft handoff scheme and a hard handoff scheme. The hard handoff is a process for enabling communication to continue while the mobile station (MS) moves between base stations (BSs) using different frequencies, or while the mobile station moves between base stations (BSs) connected to different mobile switching centers (MSCs).

The soft handoff is a process for enabling communication to continue while the mobile station moves between base stations while being connected to the same mobile switching center or between base stations using the same frequency. The soft handoff includes an inter-cell soft handoff, an inter-BSC handoff, and so on, and particularly, an inter-sector handoff is called a “softer handoff”.

The softer handoff is a process for enabling communication to continue while the mobile station moves out of a specific service region of a certain base station and thus is located at a different service region.

To this end, a mobile station measures the pilot signal strength of neighboring pilot PN included in a neighbor list and performs a set maintenance process for a handoff. In such a set maintenance process, while communicating, the mobile station continuously measures/manages not only pilot signals of an active set, which has pilot strengths larger than a predetermined threshold value (‘Pilot Strength’>‘T_ADD’), but also pilot signals of a candidate set and a neighbor set. Next, the mobile station measures reception levels, delay or relative delay of the components of received signals which have been output through multiple passes from each base station. During communication, when the level of a pilot signal received from a base station, which transmits the pilot signal included in an active set, drops below ‘T_Drop’, or when a pilot signal level received from a base station, which transmits the pilot signal included in a candidate set or a neighbor set, rises above ‘T_ADD’, the mobile station transmits a pilot strength measurement message (hereinafter, simply referred to as “PSMM”) to the base station. The base station having received the PSMM performs a handoff judgment process, and notifies the mobile station of the result of the judgment through a handoff direction message (HDM).

Hereinafter, a softer handoff process of a mobile station which is moving will be described using a series of sequences mentioned above, with reference to FIG. 1. For convenience, a handoff process in a mobile communication which supports three sectors will be explained as an example, with reference to FIG. 2.

As shown in FIG. 2, a base station system supports three sectors, that is, an a sector 201, a β sector 202, and a γ sector 203. A mobile station moves from the α sector 201, which is a serving sector, to the β sector 202, which is a target sector.

Referring now to FIG. 1, when entering a handoff region, the mobile station measures the PN strength of a pilot included in a neighbor list, and transmits a PSMM, which includes a message that a pilot strength of the β sector is greater than a predetermined threshold value (Ec/Io>T_ADD), to the base station (step 100), so that a phase and a strength of a pilot newly included into the neighbor/candidate set is reported. Then, the base station obtains, from the PSMM, information that the pilot strength of the β sector is greater than a pilot strength of the α sector for the mobile terminal. In step 110, the base station reports the PSSM, which has been received from the mobile station, to a base station controller (BSC) through a channel element (CE) so that the base station controller may determine the kind of handoff. In step 120, the base station controller determines the kind of handoff to be a softer handoff, and transmits a message requesting the performance of a softer handoff to the base station through a channel element. In step 130, the base station assigns a new orthogonal code (Walsh code), and reports this to the base station controller. When the base station receives a response from the base station controller (step 140), the base station transmits a handoff direction message (HDM) to the mobile station, thereby notifying the mobile station that the mobile station is in a softer handoff state (step 150). Then, the mobile station adds a pilot PN of the α sector and a pilot PN of the β sector to the active set so that communication may be performed through both the α sector and the β sector. In step 160, the base station receives a handoff completion message (HCM), that the softer handoff has been completed, from the mobile station. Then, the base station reports the completion of the softer handoff to the base station controller in step 170, and ends the softer handoff process. After the softer handoff of the mobile station to the β sector is completed, the base station receives and combines only signals transmitted through the β sector, as shown in FIG. 2, from among signals transmitted through multiple passes from the mobile station.

Meanwhile, in a system supporting a softer handoff as described above, methods for increasing transmission rates (throughputs) of a forward link formed from a base station to a mobile station and a reverse link formed from a mobile station to a base station include a diversity method for combining the same signals transmitted through multiple passes as shown in FIG. 2 and a method using a multi-sectored system for providing service in dividing a cell into three sectors as shown in FIG. 2. In a case of increasing the number of sectors for the purpose of increasing transmission rates in the above-mentioned methods, the transmission rate of the forward link increases, but it is impossible to obtain continuous increase of the transmission rate of the reverse link.

The reason for this, in the case of the reverse link, is that the number of fingers of a base station modem, which demodulates received signals in a multi-sectored system, is limited, so as to make the application of Rx diversity impossible.

For example, it is assumed that there is a six-sectored system employing reverse-link Rx diversity and a twelve-sectored system not employing reverse-link Rx diversity. In general, since an Rx diversity gain has a value of 3 dB or more according to channel models, the transmission rate of a reverse link in the twelve-sectored system becomes less than half of the transmission rate of a reverse link in the six-sectored system. As described above, the multi-sectored system has a problem in that the transmission rate of a forward link increases but the transmission rate of a reverse link decreases.

Accordingly, there is a need for increasing the transmission rate of a reverse link in a mobile communication system supporting a softer handoff, and for combining received signals in a base station.

### SUMMARY OF THE INVENTION

Accordingly, the present invention has been made to solve the above-mentioned problems occurring in the prior art, and an object of the present invention is to provide a base station device for increasing the transmission rate of a reverse link in a mobile communication system supporting a softer handoff, and a method for combining received signals in the base station device.

To accomplish this object, in accordance with one aspect of the present invention, there is provided a base station device supporting communication service for a mobile station which is located in a cell divided into a plurality of sectors and a method thereof. The device and method comprise a receiver for receiving a signal, which is transmitted from the mobile station, through multiple paths via the plurality of sectors, and demodulating and outputting the received signal; and a combiner for combining and outputting signals output from the receiver.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a conventional softer handoff process in a mobile communication system;

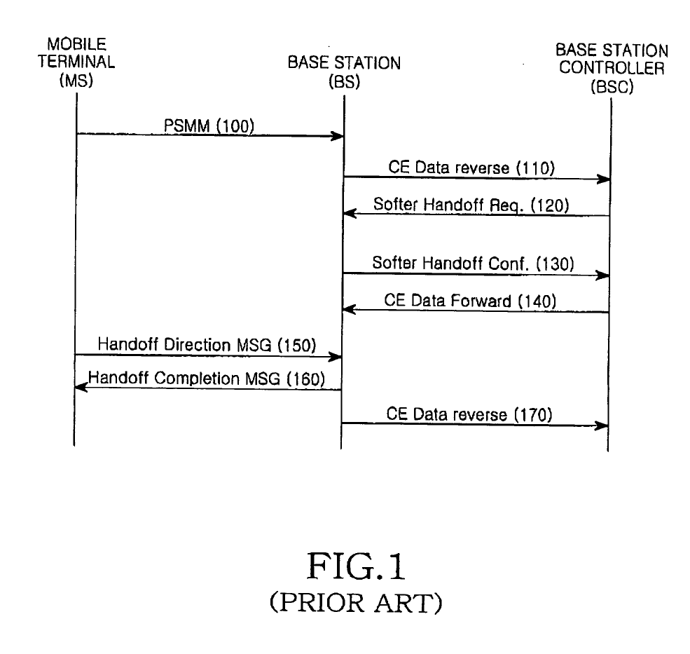

FIG. 2 is a diagram illustrating a receiving signal combination method for a reverse-link in a conventional three-sectored mobile communication system;

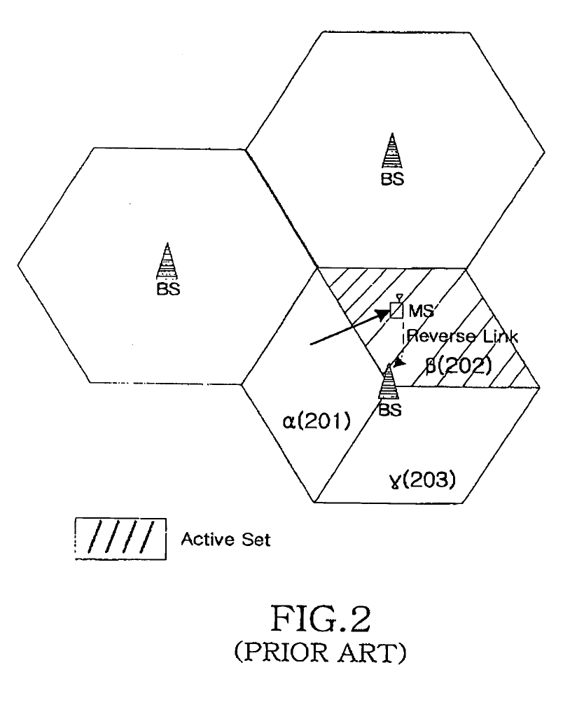

FIG. 3 is a diagram illustrating a receiving signal combination method for a reverse-link in a three-sectored mobile communication system according to an embodiment of the present invention;

FIG. 4 is a block diagram illustrating a base station device performing a reverse link receiving signal combination operation in a multi-sectored mobile communication system according to an embodiment of the present invention;

FIG. 5 is a flowchart illustrating a reverse link receiving signal combination method of a base station device in a multi-sectored mobile communication system according to an embodiment of the present invention;

FIG. 6A is a diagram illustrating a reverse link receiving signal combination method in a six-sectored mobile communication system according to an embodiment of the present invention;

FIG. 6B is a view showing simulation results of reverse-link transmission rates (throughout) according to a reverse link receiving signal combination method in a six-sectored mobile communication system according to an embodiment of the present invention;

FIG. 7A is a diagram illustrating a reverse link receiving signal combination method in a twelve-sectored mobile communication system according to an embodiment of the present invention;

FIG. 7B is a diagram illustrating simulation results of reverse-link transmission rates (throughout) according to a reverse link receiving signal combination method in a twelve-sectored mobile communication system according to an embodiment of the present invention; and

FIG. 8 is a graph displaying the change of a transmission rate in a reverse link according to the change of a signal-to-interference-and-noise ratios (SINR) in a twelve-sectored mobile communication system according to an embodiment of the present invention.

Throughout the drawings, it should be noted that the same or similar elements are denoted by like reference numerals.

### DETAILED DESCRIPTION OF THE PREFERRED EMBODIMENTS

Hereinafter, preferred embodiments according to the present invention will be described with reference to the accompanying drawings. In the following description of the present invention, a detailed description of known functions and configurations incorporated herein will be omitted for conciseness.

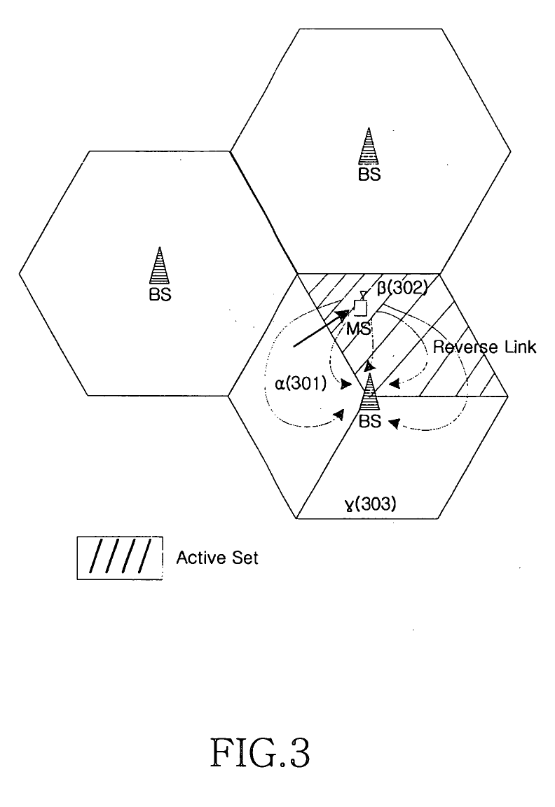

The embodiments of the present invention provide a device and a method for receiving and combining signals transmitted not only through a sector in an active set but also through a sector in a non-active set, from among signals transmitted from a specific base station, so as to increase the transmission rate of a reverse link in a mobile communication system, which includes a base station supporting a cell divided into multiple sectors. For example, in the case of a mobile communication system supporting three sectors as shown in FIG. 3, a base station receives and combines all signals transmitted not only through a β sector 302 in an active set but also through an α sector 301 and a γ sector 303.

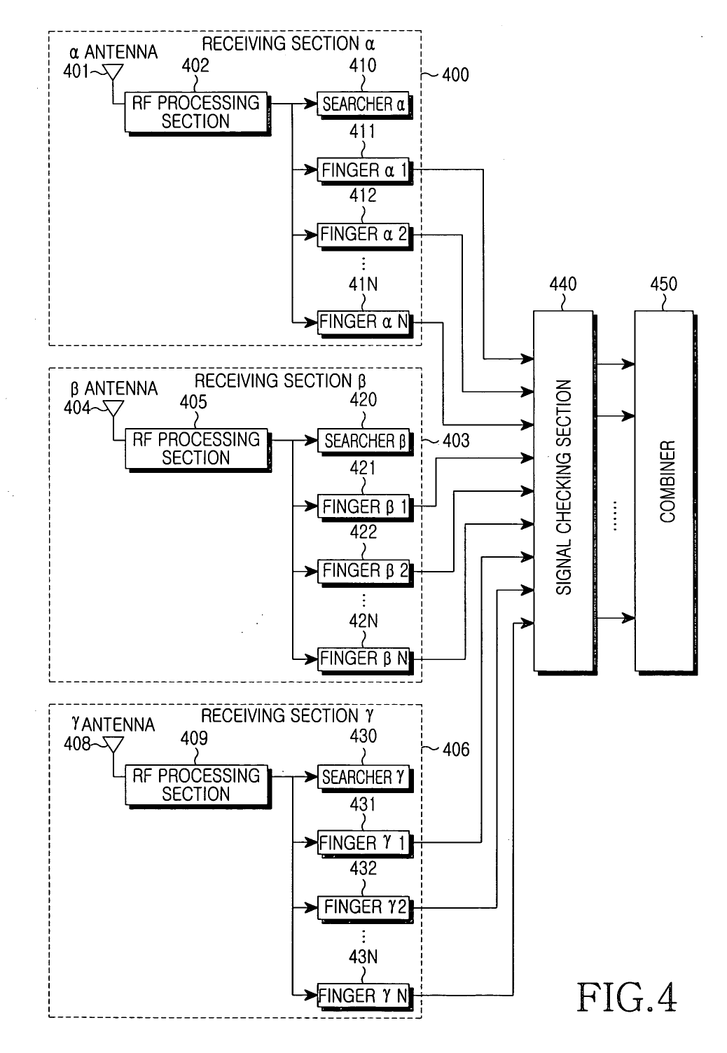

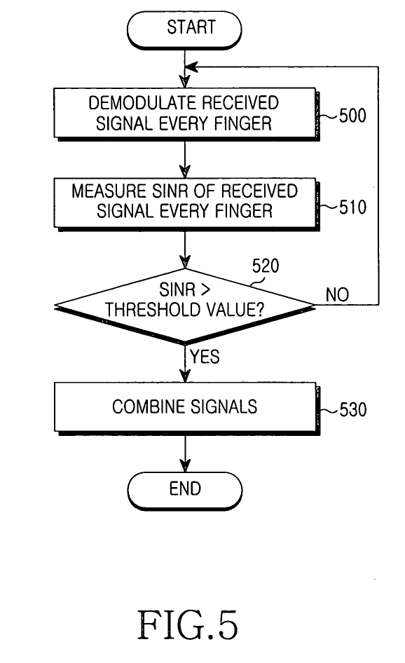

A detailed description will now be given for a base station device according to an embodiment of the present invention, as described above, and an operation of receiving and combining signals for a reverse link in the base station device with reference to FIGS. 4 and 5.

FIG. 4 is a block diagram showing a reverse link receiving signal combination device in a mobile communication system, which includes a base station supporting multiple sectors, according to one embodiment of the present invention.

The receiving signal combination device shown in FIG. 4 supports a cell divided into three sectors as shown in FIG. 3, and is constructed so that the receiving sections corresponding to each sector may receive signals at the same time. However, it should be noted that the scope of embodiments of the present invention are not limited to the device shown in FIG. 4, but can be applied to devices supporting a cell divided into six sectors, twelve sectors, and so on.

In the device shown in FIG. 4, a mobile station is located in the β sector and thus the β sector is shown as an activated sector, but the activated sector may be changed.

In addition, the reverse link receiving signal combination device shown in FIG. 4 corresponds to each specific base station.

Referring to FIG. 4, receiving section α 400 corresponds to the α sector 301 shown in FIG. 3, and receives/demodulates signals which are diffracted/reflected and transmitted via the α sector 301, from among signals output from a mobile station located in the β sector 302. To be more specific, the receiving section α 400 includes an α antenna 401, which is a directional antenna, to receive signals transmitted from the α sector 301. A Radio Frequency (RF) processing section 402 converts analog signals, which have been output from the α antenna 401, into baseband digital signals. A searcher α 410 checks intensities of signals output from the RF processing section 402, detects valid paths through which signals having intensities over a predetermined level are received, and assigns the detected paths to a plurality of fingers, that is, finger α1 411 to finger αN 41N. Each of the fingers 411 to 41N demodulates a signal received through an assigned valid path, and transmits the demodulated signal.

A receiving section β 403 and a receiving section γ 406 corresponds to the β sector 302 and the γ sector 303 shown in FIG. 3, respectively, and receives/demodulates signals which are diffracted/reflected and transmitted via the β sector 302 and the γ sector 303, respectively, from among signals output from a mobile station located in the β sector 302. Both the receiving section β 403 and the receiving section γ 406 have the same construction as that of the above-mentioned receiving section α 400.

Also, if a cell to which the base station provides service is divided into relatively many sectors, from among the receiving sections corresponding to each of the whole sectors, receiving sections corresponding to sectors opposite to the location of a mobile station receive signals of bad quality from the mobile station. Therefore, in this case, it is possible to turn off the operations of the receiving sections corresponding to sectors opposite to the location of a mobile station, by a switching signal received from a controller (not shown) included in the base station.

A signal checking section 440 measures signal-to-interference-and-noise ratios (hereinafter, simply referred to as ‘SINRs’) of signals output from the receiving sections 400, 403, and 406. The signal checking section 440 stores a predetermined SINR threshold value, and permits only signals having a SINR above the predetermined threshold value to pass to a combiner 450. Such a checking operation of the signal checking section 440 is performed for the purpose of removing unnecessary signals, such as a signal received from a sector opposite to the location of a mobile station on the basis of a base station, and receiving only signals to increase a transmission rate. That is, referring to FIG. 3, since a mobile station is located in the β sector 302, relatively more signals output from the receiving section β 403 may pass through the signal checking section 440, as compared with signals output from the receiving section α 400 and the receiving section γ 406.

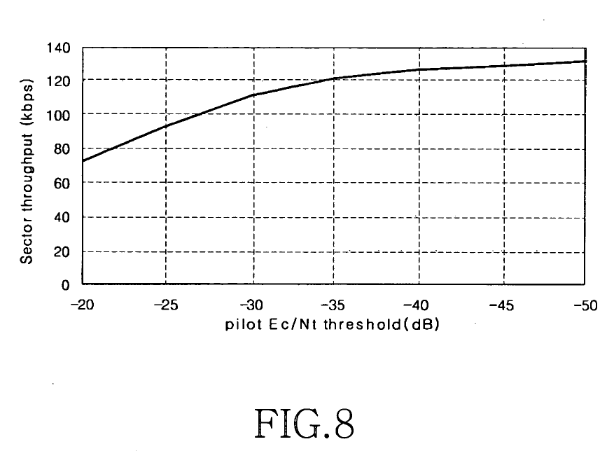

A detailed example of determining the threshold value of SINR will be described later with reference to FIG. 8.

The combiner 450 combines signals output from the signal checking section 440, and estimates original signals received through multiple receiving paths.

In the following description, the operation of the above-mentioned device will be explained with reference to a flowchart shown in FIG. 5, so as to explain a method of combining signals received through a reverse link in a base station device of a mobile communication system which supports multiple sectors according to an embodiment of the present invention.

A process of determining a sector for an active set and a sector for a non-active set through a softer handoff is identical to the conventional process described above, and is not included in the scope of the present invention. Therefore, a detailed description of the determining process will be omitted, and the description of an embodiment of the present invention will proceed on the assumption that the active set and the non-active set have been decided in advance through a softer handoff.

In step 500, receiving sections corresponding to sectors of the active set and the non-active set for a base station receive signals transmitted from a mobile station located in a specific sector. The signals received into the receiving sections are the same signals which are received during a predetermined period of time. The signals are output as analog signals from antennas 401, 404, and 408 of the respective receiving sections 400, 403, and 406, and are converted into digital baseband signals in RF processing section 402, 405, and 409. The intensities of the signals converted into the digital signals are measured in searchers 410, 420, and 430, and only signals having an intensity above a predetermined value are assigned fingers. Each of the fingers demodulates and outputs an assigned/received signal of a valid path.

Then, the signals demodulated by the respective receiving sections 400, 403, and 406 in step 500 are input to the signal checking section 440 of the base station, the signal checking section 440 measures SINRs of the input signals in step 510. In step 520, it is determined whether or not each of the SINRs is greater than a predetermined threshold value. As a result of the checking in step 520, if it is determined that an SINR is greater than the predetermined threshold value, the signal checking section 440 outputs a relevant signal to the combiner 450. In contrast, as a result of the checking in step 520, if it is determined that an SINR is not greater than the predetermined threshold value, the signal checking section 440 does not output a relevant signal to the combiner 450. Signals output to the combiner 450 are combined to be output as original signals in step 530.

That is, according to an embodiment of the present embodiment, a base station receives signals transmitted from a specific mobile station located in the region of a base station, through not only an antenna for receiving signals from a sector of an active set, in which the specific mobile station is located, but also antennas for receiving signals from different sectors in a cell. Then, the base station combines a part of the received signals which have an intensity above a predetermined value, thereby improving the transmission rate.

However, the base station device may be constructed to combine all of the received signals without determining a predetermined threshold value.

Hereinafter, an effect of improving a transmission rate according to an embodiment of the present invention will be described with reference to the results of simulations for a six-sectored system employing reverse-link Rx diversity and a twelve-sectored system not employing reverse-link Rx diversity.

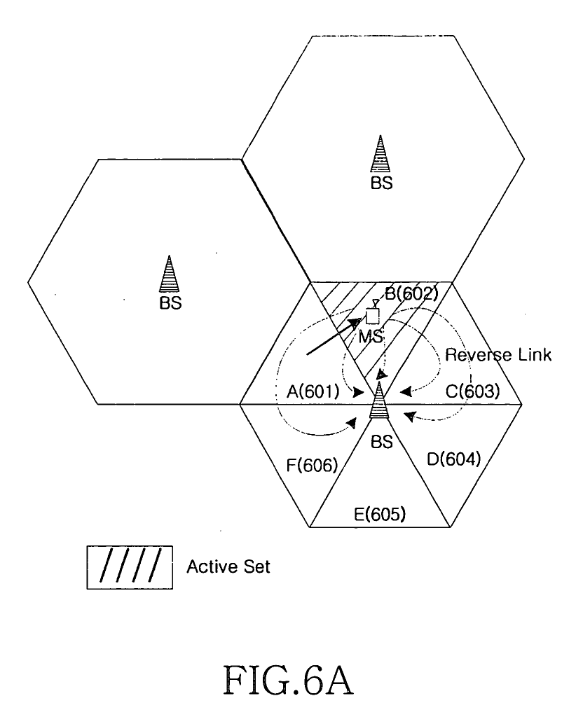

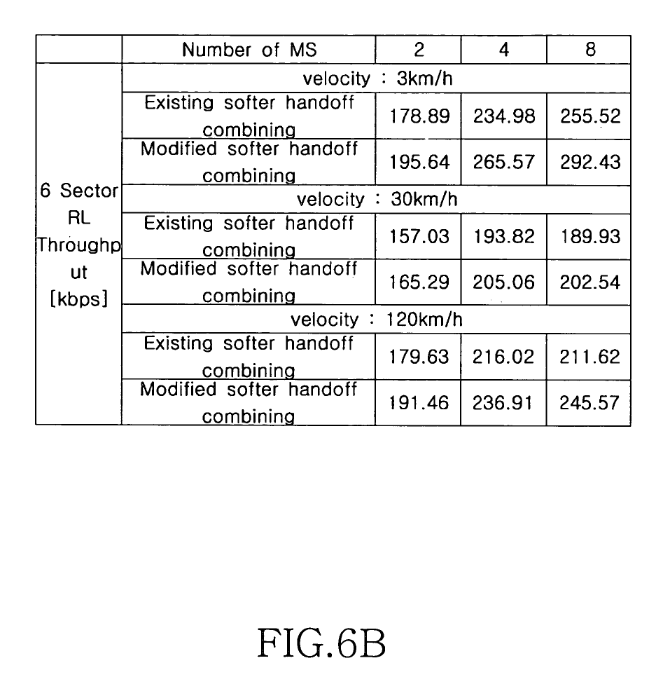

FIG. 6A is a view for explaining a method of combining signals received through a reverse link in a mobile communication system which supports two sectors according to an embodiment of the present invention.

As shown in FIG. 6A, a base station system supports six sectors which include an A sector 601, a B sector 602, a C sector 603, a D sector 604, an E sector 605, and an F sector 606. When a mobile station moves from the A sector 601, which is a serving sector, into the B sector 602, which is a target sector, a softer handoff is performed. The combiner of the base station, as described above, measures SINRs of all signals which are output from a mobile station and received through all sectors, which are included in a cell including the B sector 602 corresponding to an active set. Then, the combiner combines signals having an intensity above a specific threshold value. In the following description, simulation results of reverse-link transmission rates when a combination method of the present invention is used in the six-sectored system which employs reverse-link Rx diversity, with reference to FIG. 6B, as compared with simulation results of reverse-link transmission rates when the conventional combination method is used are provided.

FIG. 6B shows transmission rates of a reverse link according to the signal combination method of the present invention and transmission rates of a reverse link according to the conventional combination method, when each of the groups consisting of two mobile stations, four mobile stations, and eight mobile stations, respectively, are tested one group at a time in each of the fading environments of 3 km/h, 30 km/h, and 120 km/h, respectively.

When each of the groups consisting of the two mobile stations, four mobile stations, and eight mobile stations, respectively, moves at a speed of 3 km/h, for example, while each user having a mobile station is moving on foot, a transmission rate of a reverse link according to an embodiment of the present invention is 195.64 kbps, 265.57 kbps, and 292.43 kbps, respectively, while a transmission rate of a reverse link according to the prior art is 178.89 kbps, 234.98 kbps, and 255.52 kbps, respectively. Therefore, it should be understood that the transmission rate is improved via embodiments of the present invention.

When each of the groups consisting of the two mobile stations, four mobile stations, and eight mobile stations, respectively, moves at a speed of 30 km/h, for example, while each user having a mobile station is riding on a bicycle, a transmission rate of a reverse link according to an embodiment of the present invention is 165.29 kbps, 205.06 kbps, and 202.54 kbps, respectively, while a transmission rate of a reverse link according to the prior art is 157.03 kbps, 193.82 kbps, and 189.93 kbps, respectively. Therefore, it should be understood that the transmission rate is also improved via the embodiments of the present invention.

When each of the groups consisting of the two mobile stations, four mobile stations, and eight mobile stations, respectively, moves at a speed of 120 km/h, for example, while each user having a mobile station is riding in a car, a transmission rate of a reverse link according to an embodiment of the present invention is 191.46 kbps, 236.91 kbps, and 245.57 kbps, respectively, while a transmission rate of a reverse link according to the prior art is 179.63 kbps, 216.02 kbps, and 211.62 kbps, respectively.

As described above, in the case of the six-sectored system, it should be understood that the transmission rate of a reverse link according to embodiment of the present invention is increased by 1.06 to 1.14 times as compared with the prior art.

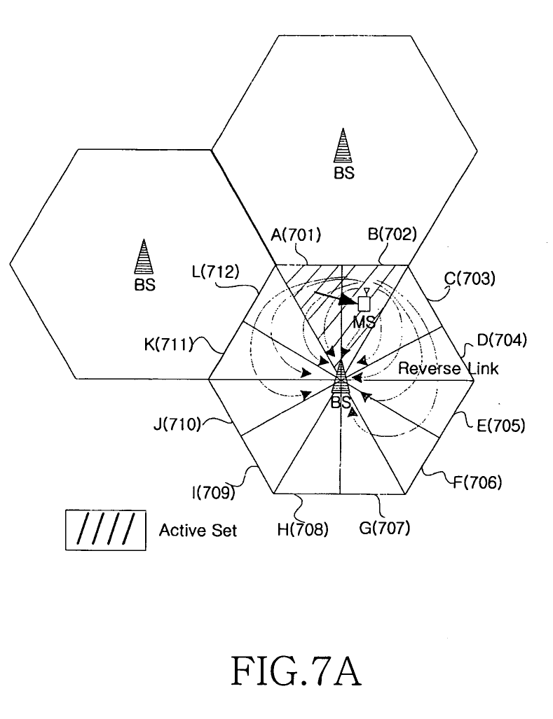

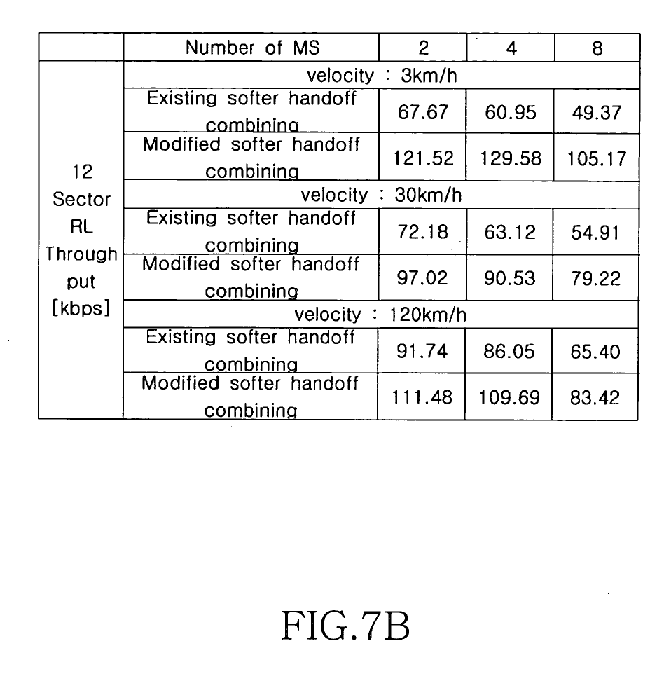

FIG. 7A is a diagram illustrating a method of combining signals of a in a mobile communication which supports twelve sectors according to an embodiment of the present invention.

As shown in FIG. 7A, a base station system supports twelve sectors which include an A sector 701, a B sector 702, a C sector 703, a D sector 704, an E sector 705, an F sector 706, a G sector 707, an H sector 708, an I sector 709, a J sector 710, a K sector 711, and an L sector 712. When a mobile station moves from the A sector 701, which is a serving sector, into the B sector 702, which is a target sector, a softer handoff is performed. The combiner of the base station, as described above, measures SINRs of all signals which are output from a mobile station and received through all sectors, which are included in a cell including the B sector 702 corresponding to an active set. Then, the combiner combines signals having an intensity above a specific threshold value. In the following description, simulation results of reverse-link transmission rates when a combination method of the present invention is used in the twelve-sectored system which does not employ reverse-link Rx diversity, with reference to FIG. 7B, as compared with simulation results of reverse-link transmission rates when the conventional combination method is used.

FIG. 7B shows transmission rates of a reverse link according to the signal combination method of the present invention and transmission rates of a reverse link according to the conventional combination method, when each of the groups consisting of two mobile stations, four mobile stations, and eight mobile stations, respectively, are tested one group at a time in each of the fading environments of 3 km/h, 30 km/h, and 120 km/h, respectively, as shown in FIG. 6B.

When each of the groups consisting of the two mobile stations, four mobile stations, and eight mobile stations, respectively, moves at a speed of 3 km/h, for example, while each user having a mobile station is moving on foot, a transmission rate of a reverse link according to an embodiment of the present invention is 121.52 kbps, 129.58 kbps, and 105.17 kbps, respectively, while a transmission rate of a reverse link according to the prior art is 67.67 kbps, 60.95 kbps, and 49.37 kbps, respectively. Therefore, it should be understood that the transmission rate is greatly improved via the embodiments of the present invention.

When each of the groups consisting of the two mobile stations, four mobile stations, and eight mobile stations, respectively, moves at a speed of 30 km/h, for example, while each user having a mobile station is riding on a bicycle, a transmission rate of a reverse link according to an embodiment of the present invention is 97.02 kbps, 90.53 kbps, and 79.22 kbps, respectively, while a transmission rate of a reverse link according to the prior art is 72.18 kbps, 63.12 kbps, and 54.91 kbps, respectively. Therefore, it should be understood that the transmission rate is improved via the embodiments of the present invention.

When each of the groups consisting of the two mobile stations, four mobile stations, and eight mobile stations, respectively, moves at a speed of 120 km/h, for example, while each user having a mobile station is riding in a car, a transmission rate of a reverse link according to an embodiment of the present invention is 111.48 kbps, 109.69 kbps, and 83.42 kbps, respectively, while a transmission rate of a reverse link according to the prior art is 91.74 kbps, 86.05 kbps, and 65.40 kbps, respectively. As described above, in the case of the twelve-sectored system, it should be understood that the transmission rate of a reverse link according to the embodiment of the present invention is increased by 1.22 to 2.13 times as compared with the prior art. Referring to the simulation results, the transmission rates of a reverse link in the twelve-sectored system are measured as lower values than those in the six-sectored system employing Rx diversity because the twelve-sectored system does not employ Rx diversity.

As shown in the simulation results, in the case of the six-sectored system employing Rx diversity, the transmission rate of a reverse link according to the signal combination method of the present invention is increased by 1.06 to 1.14 times as compared with that of the prior art. In addition, in the case of the twelve-sectored system which does not employ Rx diversity, the transmission rate of a reverse link according to the signal combination method of the present invention is increased by 1.22 to 2.13 times as compared with that of the prior art. The case of not employing Rx diversity shows a greater increase in transmission rate than the case of employing Rx diversity.

FIG. 8 is a graph showing the change of a transmission rate of a reverse link according to the change of a pilot Ec/Nt threshold value (SINR threshold value) when two mobile stations are in a fading environment of 30 km/h in a system which is constructed with a cell divided into twelve sectors.

Referring to FIG. 8, in cases of relatively high threshold values, transmission rates of a reverse link according to the reverse-link combination method of the present invention are almost identical to those of the conventional combination method.

However, it should be understood that the transmission rate of a reverse link shows a significant increase according to the decrease of the threshold value, and the increase amount of the transmission rate of a reverse link becomes very small when the pilot Ec/Nt threshold value decreases to a value less than −36 dB. As shown in these simulation results, when a specific threshold value is predetermined for each finger in the base station modem so that the base station modem may not find weak signals the detecting of which is difficult, and may combine only signals above the specific threshold value from among signals received from a mobile station through all sectors, which exist in a cell including a specific sector corresponding to an active set, it is possible to increase the transmission rate of a reverse link as compared with the conventional method.

As described above, the embodiments of the present invention have the following advantages. First, a base station combines signals, which are output from a mobile station and received through all sectors included in a cell that includes a specific sector corresponding to an active set, so that the transmission rate of a reverse link can be improved.

Secondly, a specific threshold value is predetermined for each finger in the base station modem so that the base station modem may not find weak signals the detecting of which is difficult, and may combine only signals above the specific threshold value, so that the transmission rate of a reverse link can be improved.

While the present invention has been shown and described with reference to certain embodiments thereof, it should be understood by those skilled in the art that various changes in form and details may be made therein without departing from the spirit and scope of the invention as defined by the appended claims.

1. A base station device supporting communication service for a mobile station which is located in a cell divided into a plurality of sectors, the device comprising:
a receiver for receiving a signal, which is transmitted from the mobile station, through multiple paths via the plurality of sectors, and demodulating and outputting the received signal; and
a combiner for combining and outputting signals output from the receiver.

2. The device as claimed in claim 1, wherein, the receiver selects at least one sector from among the plurality of sectors including an active sector in the cell in which the mobile station is located, and receives signals output through the active sector and the selected sector.

3. The device as claimed in claim 1, further comprising a signal checking section, which checks signal-to-interference-and-noise ratios of signals output from the receiver, and outputs signals, that have a signal-to-interference-and-noise ratio above a predetermined threshold value, to the combiner.

4. The device as claimed in claim 1, wherein, the receiver includes a plurality of receiving sections each of which corresponds to at least one of the sectors.

5. The device as claimed in claim 4, wherein, the receiving section comprises:
a signal processing section for converting signals received through an antenna corresponding to one sector of the sectors into digital baseband signals, and outputting the converted signals;
a searcher for checking intensities of signals output from the signal processing section, and for detecting valid paths through which signals having intensities over a predetermined level are received; and
a plurality of fingers for demodulating signals received through the valid paths, which are detected by the searcher, and for outputting the demodulated signals.

6. The device as claimed in claim 5, wherein the antenna is a directional antenna constructed so as to correspond to each sector.

7. The device as claimed in claim 5, wherein the operations of the receiving sections are turned on or off according to a control signal input externally.

8. The device as claimed in claim 5, wherein, the operation of at least one receiving section, which corresponds to a location opposite to the mobile station on the basis of the base station, is turned off according to a control signal input externally.

9. A method of supporting communication service for a mobile station which is located in a cell divided into a plurality of sectors, the method comprising the steps of:
1) receiving substantially the same signal, which is transmitted from the mobile station, through the plurality of sectors, and modulating and outputting the received signals; and
2) combining and outputting the modulated signals.

10. The method as claimed in claim 9, wherein, in step 1), at least one sector is selected from among the plurality of sectors including an active sector in the cell in which the mobile station is located, and signals output through the active sector and the selected sector are received.

11. The method as claimed in claim 9, wherein step 1) further comprises a step of checking signal-to-interference-and-noise ratios of the demodulated signals and passing signals which have a signal-to-interference-and-noise ratio above a predetermined threshold value.
